(19) United States
(12) Patent Application Publication
(10) Pub. No.: US 2021/0170635 A1
(43) Pub. Date: Jun. 10, 2021

(54) MOLDING SUPPORT APPARATUS AND MOLDING SUPPORT METHOD

(71) Applicant: Konica Minolta, Inc., Chiyoda-ku (JP)

(72) Inventor: Ikuma OTA, Setagaya-ku (JP)

(73) Assignee: Konica Minolta, Inc.

(21) Appl. No.: 17/109,541

(22) Filed: Dec. 2, 2020

(30) Foreign Application Priority Data
Dec. 4, 2019 (JP) 2019-219347

(51) Int. Cl. B29C 33/38; G05B 19/4155

(52) U.S. Cl. CPC B29C 33/3835; G05B 2219/45244; G05B 19/4155

(57) ABSTRACT

Provided is a molding support apparatus that supports production of a molded product of a composite material, and the apparatus includes: a hardware processor that calculates a Talbot feature of the molded product, based on a Talbot image acquired from an X-ray Talbot imaging apparatus that images the molded product, and identifies, using the calculated Talbot feature, an item that allows adjustment of the Talbot feature from among a plurality of types of items constituting a production process for producing the molded product.

The entire disclosure of Japanese patent Application No. 2019-219347, filed on Dec. 4, 2019, is incorporated herein by reference in its entirety.

### BACKGROUND

### Technological Field

The present invention relates to a molding support apparatus and a molding support method.

### Description of the Related Art

JP 2019-184450 A discloses an “X-ray imaging system for estimating an evaluation index used to determine the quality of an object under inspection, based on a reconstructed image of the object under inspection captured by an X-ray Talbot imaging apparatus, the X-ray Talbot imaging apparatus including an X-ray source, a plurality of gratings, and an X-ray detector aligned in an X-ray radiation axis direction for applying X-rays from the X-ray source through the object under inspection that is a subject and the plurality of gratings to the X-ray detector to acquire a moire image required to generate a reconstructed image of the object under inspection, the X-ray imaging system comprising a control unit and a first database showing correlation between information regarding signal intensity in the reconstructed image generated based on the moire image, and quality information of a material forming the object under inspection, on an individual material name or type basis, the control unit estimating, as the evaluation index, quality information at a portion of interest of the object under inspection from the reconstructed image, based on information on a name or type of the material and shape information input, and the first database”.

JP 6489529 B1 discloses a “method of estimating a state of an electrochemical apparatus including a secondary battery or a storage battery which is a structural complex including a plurality of members for exhibiting an intended function, in which a database is prepared which includes a plurality of direct parameters obtained by destructive inspection of a plurality of structural complexes with different operating conditions and/or operating times, and a plurality of indirect parameters obtained by non-destructive measurement of a plurality of structural complexes identical to the aforementioned structural complexes, in which database, each of the direct parameters corresponds to a structural factor reflecting a specific performance capability of the structural complex, each of the indirect parameters corresponds to a plurality of structural factors indirectly defining a plurality of performance capabilities of the structural complex, each indirect parameter is decomposed into a plurality of subparameters, the subparameters are associated with the direct parameters, and the direct parameters and the indirect parameters are associated with each other, the structural complex state estimation method comprising a step of measuring a plurality of indirect parameters for a structural complex that is an object, a step of extracting a plurality of subparameters from the measured indirect parameters, and a step of estimating a state of the structural complex indicated by a plurality of performance capabilities by associating the extracted subparameters with the direct parameters, using the database”.

In recent years, the development of composite materials containing resin and fiber has advanced. It is known that the performance of a composite material is affected not only by the quality of the composite material but also by the fine internal structure of the composite material. For example, carbon fiber reinforced plastics (CFRP) as composite materials have a three-dimensional structure due to the weave and orientation of carbon fibers. The mechanical strength of CFRP is greatly affected by the fiber orientation, the fiber density, and the number of defects. JP 2019-184450 A and JP 6489529 B1 can be said to be means for grasping the fine internal structure of a composite material.

By the way, a composite material is produced by, for example, injection molding. There is room to improve the performance of a composite material as a molded product by changing a production process such as the mold design of a mold used for injection molding or the molding conditions of injection molding. However, a production process has often been determined based on a producer's intuition, knacks, and experience partly because of a lack of a basis for objective judgement, limiting performance improvement of a molded product.

### SUMMARY

In view of the above circumstances, it is an object of the present invention to support performance improvement of a molded product.

To achieve the abovementioned object, according to an aspect of the present invention, there is provided a molding support apparatus that supports production of a molded product of a composite material, and the molding support apparatus reflecting one aspect of the present invention comprises: a hardware processor that calculates a Talbot feature of the molded product, based on a Talbot image acquired from an X-ray Talbot imaging apparatus that images the molded product, and identifies, using the calculated Talbot feature, an item that allows adjustment of the Talbot feature from among a plurality of types of items constituting a production process for producing the molded product.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is an overall schematic diagram of an X-ray Talbot imaging apparatus;

FIG. 2 is a diagram illustrating the principle of a Talbot interferometer;

FIG. 3 is a schematic plan view of a source grating, a first grating, and a second grating;

FIG. 4 is a block diagram showing the schematic configuration of an X-ray imaging system;

FIG. 5 is a graph showing the relationship between brightness (intensity) I and angle θ in each pixel in the generation of an elliptical display image;

FIG. 6 is an example of an elliptical display image in each pixel;

FIG. 7 is an example of elliptical display images in a plurality of pixels;

FIG. 8A is a histogram display of orientation statistical information of a pha image, and FIG. 8B is a polar coordinate display of the histogram of the pha image;

FIG. 9 is a display example of an orientation statistical information image;

FIG. 10 is a flowchart showing processing required for Example 1: feedback to mold design (part 1);

FIG. 11 is a schematic diagram of an orientation color map image of a resin gear as a molded product;

FIG. 12 is a flowchart showing processing required for Example 2: feedback to mold design (part 2);

FIG. 13 is a diagram showing orientations (double-headed arrows) of resin in individual CAE meshes;

FIG. 14 is a diagram showing orientations (double-headed arrows) of fiber (resin) in a ROI of a pha image;

FIG. 15 is an example of a screen display by a comparison viewer;

FIG. 16 is a graph showing the distribution of a two-dimensional scattering function;

FIG. 17 is a flowchart showing processing for determination of optimum molding conditions by machine learning (part 1) in Example 3: feedback to molding conditions;

FIG. 18 is a flowchart showing processing for determination of optimum molding conditions by machine learning (part 2) in Example 3: feedback to molding conditions;

FIG. 19A is a display example of an image (A₀(x, y)), and FIG. 19B is a display example of an image (A₉₀(x, y));

FIG. 20A is a graph of a differential phase signal in an x direction, and FIG. 20B is a graph of a differential phase signal in a y direction for the image (A₀(x, y));

FIG. 21A is a graph of the value of change in the differential phase signal in the x direction, and FIG. 21B is a graph of the value of change in the differential phase signal in the y direction for the image (A₀(x, y));

FIG. 22A is a graph of a differential phase signal in an x direction, and FIG. 22B is a graph of a differential phase signal in a y direction for the image (A₉₀(x, y));

FIG. 23A is a graph of the value of change in the differential phase signal in the x direction, and FIG. 23B is a graph of the value of change in the differential phase signal in the y direction for the image (A₉₀(x, y));

FIG. 24 is a display example of an image (DA₀(x, y));

FIG. 25 is a display example of an image (DA₉₀(x, y)); and

FIG. 26 is a display example of a composite image.

### DETAILED DESCRIPTION OF EMBODIMENTS

Hereinafter, one or more embodiments of the present invention will be described with reference to the drawings. However, the scope of the invention is not limited to the disclosed embodiments. In the description of the drawings, the same reference numerals are assigned to the same elements without duplicated explanations. Some dimensional ratios in the drawings may be exaggerated for convenience of explanation and differ from actual ratios.

In the present embodiment, an “image” means image data except in exceptional circumstances.

In the present embodiment, an X-ray imaging system (hereinafter sometimes simply referred to as a “system”) will be described which is for supporting determination of a mold design and molding conditions for molding a molded product, using a reconstructed image of an object under inspection that is a subject H imaged by an X-ray Talbot imaging apparatus 1. A subject in the present embodiment is, for example, a molded product or pellets to be put into a molding machine at the time of molding, but is not limited to these.

<About Subject>

The subject H in the present embodiment is formed by a composite (also referred to as a composite material). The composite material means a material in which two or more different materials are integrally combined, and means one in which at least two materials exist as phases. Therefore, those mixed to form a single material like alloys and ceramic are not included in composite materials. For example, composite materials are used as constituent members of various products and others including, for example, space- and aircraft-related ones, automobiles, ships, and fishing rods, and further, electric, electronic, and home appliance parts, parabolic antennas, bathtubs, flooring materials, roofing materials, etc.

As such composites, for example, fiber-reinforced plastics (FRP) using carbon fiber or glass fiber as reinforcing fiber typified by carbon fiber-reinforced plastics (CFRP), carbon fiber-reinforced thermoplastics (CFRTP), and glass fiber-reinforced plastics (GFRP), ceramic matrix composites (CMC) that use ceramic fiber as a reinforcing material, and the like are known. In a broad sense, composites made of a plurality of types of wood such as plywood may be included. In addition, composite materials formed without containing fiber such as metal matrix composite (MMC) concrete and reinforced concrete may be included.

Materials (referring to composites as described above) constituting an object under inspection, which is the subject H, have different properties (mechanical strengths) depending on their types. Data on the individual types are stored and accumulated in the system.

Likewise, pieces of material shape information are different in mechanical strength depending on the shapes. Data on the individual shapes are stored and accumulated in the system.

Mechanical strength refers to, for example, an elastic modulus, yield strength, plasticity, tensile strength, elongation, fracture energy, hardness, etc.

The shape information mainly includes thickness information (thickness dimension), CAD data, and three-dimensional (3D) data such as measurement data obtained by a three-dimensional measuring instrument. As other shape information, for example, information such as an uneven location in a material, or whether it is netlike or layered may be included.

Resins used in composite materials are, for example, commodity plastics, engineering plastics, and super engineering plastics, but are not limited to these. Resins are used as resin composite materials to which a filler having a micro-sized or nano-sized structure is added to add predetermined properties such as strength, and are often used as plastic molded products. Fillers include organic materials, inorganic materials, magnetic materials, and metallic materials. For example, when strength and rigidity are required for a plastic molded product, a composite material of PPS, POM, PA or the like as resin and GF, aramid fiber, mica, or the like as filler may be used. When a plastic molded product is a thin object, a composite material of a liquid crystal polymer and GF may be used. When a plastic molded product is a plastic magnet, a composite material of nylon as resin and strontium ferrite, samarium cobalt, or the like as filler is often used.

<About X-Ray Talbot Imaging Apparatus>

As the X-ray Talbot imaging apparatus 1, the present embodiment employs one using a Talbot-Lau interferometer including a source grating (also referred to as a multi-grating, a multi-slit, a G0 grating, or the like) 12. An X-ray Talbot imaging apparatus using a Talbot interferometer can also be employed which does not include the source grating 12 but only includes a first grating (also referred to as a G1 grating) 14 and a second grating (also referred to as a G2 grating) 15.

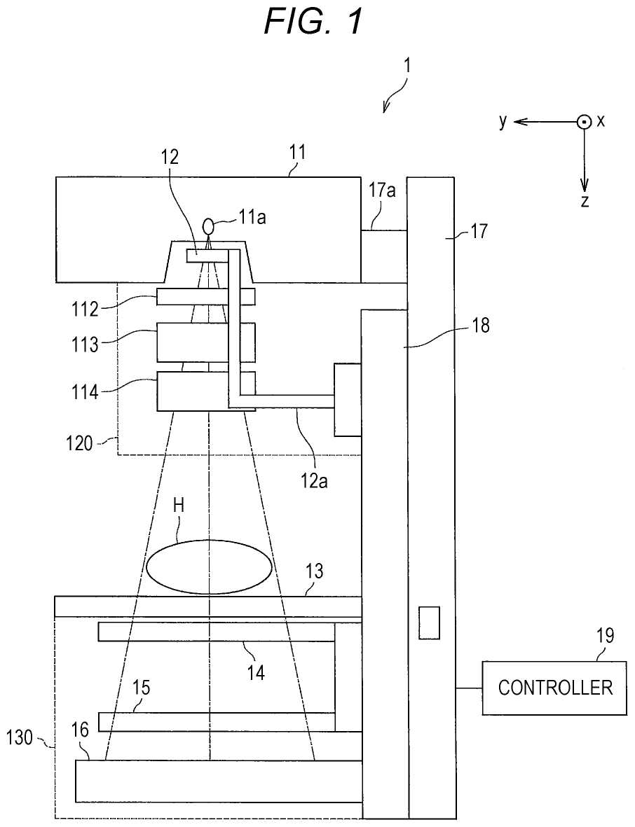

FIG. 1 is a schematic diagram showing an overall image of the X-ray Talbot imaging apparatus 1.

The X-ray Talbot imaging apparatus 1 according to the present embodiment includes an X-ray generator 11, the above-mentioned source grating 12, a subject table 13, the above-mentioned first grating 14, the above-mentioned second grating 15, an X-ray detector 16, a pillar 17, and a base 18.

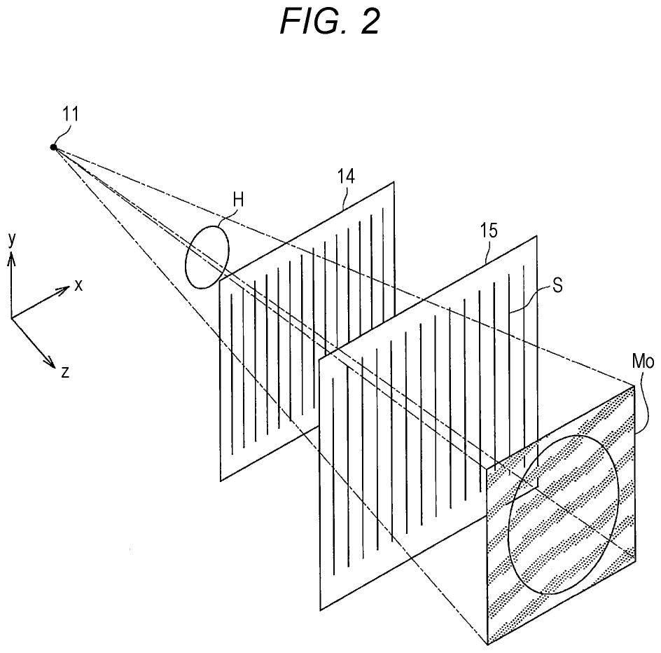

This X-ray Talbot imaging apparatus 1 can reconstruct at least three types of images (two-dimensional images) (referred to as reconstructed images) by capturing moire images Mo (FIG. 2) of the subject H located at a predetermined position with respect to the subject table 13 by a method based on the principle of the fringe scanning method, or analyzing a moire image Mo by a Fourier transform method. Specifically, the three types of images are an absorption image in which an average component of moire fringes in a moire image Mo is rendered visible (the same as a normal X-ray absorption image), a differential phase image in which phase information of the moire fringes is rendered visible, and a small-angle scattering image in which the visibility of the moire fringes is rendered visible. By recombining these three types of reconstructed images, for example, more types of images can be generated.

The fringe scanning method is a method to perform reconstruction using moire images Mo obtained by M-time imaging with one of a plurality of gratings shifted by 1/M of the slit period of the grating (M is a positive integer, M>2 for an absorption image, and M>3 for a differential phase image and a small-angle scattering image) in a slit period direction, to obtain high-definition reconstructed images.

The Fourier transform method is a method by which the X-ray Talbot imaging apparatus 1 captures a single moire image Mo in the presence of the subject H, and the moire image Mo is subjected to Fourier transform or the like to reconstruct and generate images such as a differential phase image in image processing.

Here, first, the principle common to Talbot interferometers and Talbot-Lau interferometers will be described with reference to FIG. 2.

Although FIG. 2 shows a case of a Talbot interferometer, a case of a Talbot-Lau interferometer will be described basically the same. A z direction in FIG. 2 corresponds to a vertical direction in the X-ray Talbot imaging apparatus 1 in FIG. 1, and x and y directions in FIG. 2 correspond to horizontal directions (front-back and left-right directions) in the X-ray Talbot imaging apparatus 1 in FIG. 1.

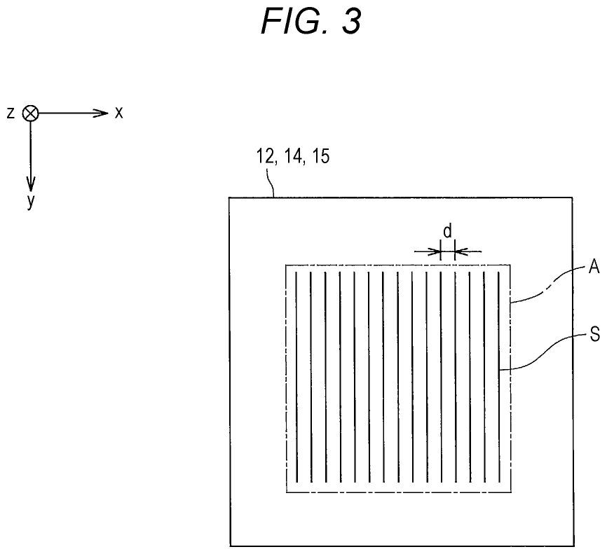

As shown in FIG. 3, in the first grating 14 and the second grating 15 (also in the source grating 12 in the case of the Talbot-Lau interferometer), multiple slits S are aligned and formed with a predetermined period d in the x direction orthogonal to the z direction that is the X-ray radiation direction. This alignment of the slits S is referred to as a one-dimensional grating. One with slits S aligned and formed in the x direction and the y direction is referred to as a two-dimensional grating.

For the source grating 12, the first grating 14, and the second grating 15 of the present embodiment, one-dimensional gratings are used. If a detailed evaluation accuracy for fiber orientation is not required, two-dimensional gratings may be used.

As shown in FIG. 2, when X-rays emitted from an X-ray source 11a (in the case of the Talbot-Lau interferometer, X-rays emitted from the X-ray source 11a and converted into multiple light sources at the source grating 12 (not shown in FIG. 2)) pass through the first grating 14, the X-rays that have passed therethrough form images at regular intervals in the z direction. These images are called self-images (also referred to as grating images or the like). A phenomenon in which self-images are formed at regular intervals in the z direction like this is called the Talbot effect.

That is, the Talbot effect refers to a phenomenon in which coherent light that has passed through the first grating 14 provided with the slits S with the certain period d as shown in FIG. 3 forms self-images at regular intervals in the traveling direction of the light as described above.

As shown in FIG. 2, the second grating 15 provided with the slits S like the first grating 14 is disposed at a position where a self-image of the first grating 14 is formed. At that time, if the second grating 15 is disposed such that the extending direction of the slits S thereof (that is, the y-axis direction in FIG. 2) is substantially parallel to the extending direction of the slits S of the first grating 14, a moire image Mo is obtained on the second grating 15.

Note that FIG. 2 describes the moire image Mo apart from the second grating 15 because if the moire image Mo is described on the second grating 15, moire fringes are mixed with the slits S and become obscure. However, in actuality, the moire image Mo is formed on the second grating 15 and on the downstream side thereof. Then, the moire image Mo is captured by the X-ray detector 16 disposed immediately below the second grating 15.

When the subject H is present between the X-ray source 11a and the first grating 14 as shown in FIGS. 1 and 2, the phase of X-rays is displaced by the subject H, and thus moire fringes of the moire image Mo are disturbed at the peripheral edge of the subject H. On the other hand, although not shown, if the subject H is not present between the X-ray source 11a and the first grating 14, the moire image Mo only with moire fringes appears. The above is the principle of Talbot interferometers and Talbot-Lau interferometers.

Based on this principle, also in the X-ray Talbot imaging apparatus 1 according to the present embodiment, as shown in FIG. 1, for example, the second grating 15 is disposed at a position where a self-image of the first grating 14 is formed in a second cover unit 130. As described above, the X-ray detector 16 is disposed immediately below the second grating 15 in the present embodiment because if the second grating 15 is set apart from the X-ray detector 16, the moire image Mo (see FIG. 2) is blurred. The second grating 15 may be formed of a light-emitting material such as scintillator or amorphous selenium to integrate the second grating 15 with the X-ray detector 16.

The second cover unit 130 is provided to prevent a person or an object from hitting or touching the first grating 14, the second grating 15, the X-ray detector 16, and others to protect the X-ray detector 16 and others.

Although not shown, the X-ray detector 16 includes conversion elements arranged in a two-dimensional form (a matrix) for generating electrical signals in proportion to X-rays applied, so as to read the electrical signals generated by the conversion elements as image signals. In the present embodiment, the X-ray detector 16 captures the above-described moire image Mo, which is an X-ray image formed on the second grating 15, as image signals of the individual conversion elements. The pixel size of the X-ray detector 16 is 10 to 300 (μm), and more desirably, 50 to 200 (μm).

A flat-panel detector (FPD) can be used as the X-ray detector 16. FPDs have an indirect conversion type that converts detected X-rays into electrical signals through photoelectric conversion elements, and a direct conversion type that directly converts detected X-rays into electrical signals. Either type can be used.

In the indirect conversion type, photoelectric conversion elements are arranged in a two-dimensional form together with thin film transistors (TFTs) under a scintillator plate of CsI, Gd2O2S, or the like, to form pixels. When X-rays incident on the X-ray detector 16 are absorbed into the scintillator plate, the scintillator plate emits light. Due to the emitted light, charge is accumulated in the photoelectric conversion elements, and the accumulated charge is read out as image signals.

In the direct conversion type, an amorphous selenium film with a film pressure of 100 to 1000 (μm) is formed on glass by thermal deposition of amorphous selenium, and the amorphous selenium film and electrodes are vapor-deposited on an array of TFTs arranged in a two-dimensional form. When the amorphous selenium film absorbs X-rays, voltage is released in the substance in the form of electron-hole pairs, and voltage signals between electrodes are read by the TFTs.

An imaging means such as a charge-coupled device (CCD) or an X-ray camera may alternatively be used as the X-ray detector 16.

In the present embodiment, the X-ray Talbot imaging apparatus 1 captures a plurality of moire images Mo using the so-called fringe scanning method. Specifically, the X-ray Talbot imaging apparatus 1 according to the present embodiment captures a plurality of moire images Mo, shifting the relative positions of the first grating 14 and the second grating 15 in the x-axis direction (that is, a direction orthogonal to the extending direction of the slits S (the y-axis direction) in FIGS. 1 to 3.

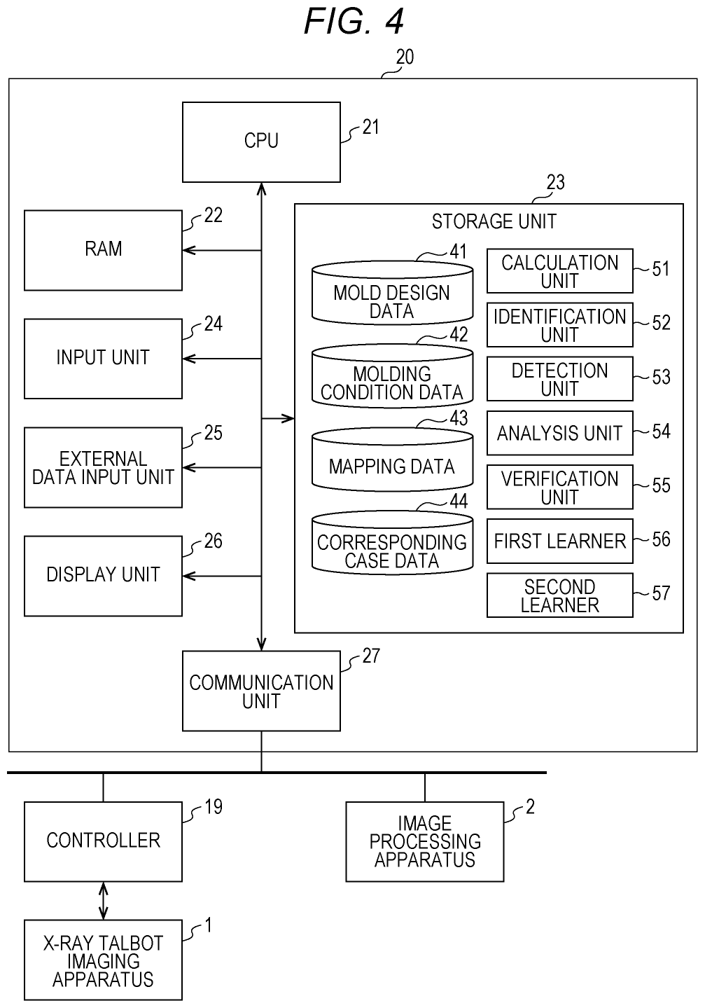

Then, by image processing in an image processing apparatus 2 (see FIG. 4) that has received image signals of the plurality of moire images Mo from the X-ray Talbot imaging apparatus 1, an absorption image, a differential phase image, a small-angle scattering image, etc. are reconstructed based on the plurality of moire images Mo (that is, image reconstruction).

Therefore, the X-ray Talbot imaging apparatus 1 according to the present embodiment can move the first grating 14 in the x-axis direction by a predetermined amount at a time in order to capture a plurality of moire images Mo by the fringe scanning method. Instead of moving the first grating 14, the second grating 15 may be moved, or both may be moved.

The X-ray Talbot imaging apparatus 1 may alternatively capture only one moire image Mo with the relative positions of the first grating 14 and the second grating 15 fixed, and by image processing in the image processing apparatus 2, the moire image Mo may be, for example, analyzed using the Fourier transform method or the like to reconstruct an absorption image, a differential phase image, etc.

The configurations of the other parts in the X-ray Talbot imaging apparatus 1 according to the present embodiment will be described. The present embodiment is of a so-called vertical type, and the X-ray generator 11, the source grating 12, the subject table 13, the first grating 14, the second grating 15, and the X-ray detector 16 are disposed in this order in the z direction that is the gravity direction. That is, in the present embodiment, the z direction is the radiation direction of X-rays from the X-ray generator 11.

The X-ray generator 11 includes, as the X-ray source 11a, for example, a Coolidge X-ray source, a rotating anode X-ray source, or the like widely used in medical settings. Other X-ray sources can also be used. The X-ray generator 11 of the present embodiment emits X-rays in the form of a cone beam from the focal point. That is, as shown in FIG. 1, X-rays are emitted so as to become wider as they move away from the X-ray generator 11 with an X-ray radiation axis Ca coinciding with the z direction as a central axis (i.e., an X-ray radiation range).

In the present embodiment, the source grating 12 is provided below the X-ray generator 11. At that time, in order to prevent vibrations of the X-ray generator 11 caused by rotation of the anode of the X-ray source 11a or the like from being transmitted to the source grating 12, the source grating 12 is not mounted to the X-ray generator 11 but is mounted to a fixing member 12a that is mounted to the base 18 provided on the pillar 17 in the present embodiment.

In the present embodiment, in order to prevent vibrations of the X-ray generator 11 from propagating to the other parts of the X-ray Talbot imaging apparatus 1 such as the pillar 17 (or to make propagating vibrations smaller), a cushioning member 17a is provided between the X-ray generator 11 and the pillar 17.

In the present embodiment, in addition to the source grating 12, a filtration filter (also referred to as an additional filter) 112 for changing the radiation quality of X-rays transmitted through the source grating 12, a radiation-field-narrowing device 113 for narrowing the radiation field of X-rays applied, and a radiation field lamp 114 for irradiating the subject with visible light instead of X-rays before application of X-rays for alignment, for example, are mounted to the fixing member 12a.

The source grating 12, the filtration filter 112, and the radiation-field-narrowing device 113 do not necessarily have to be provided in this order. In the present embodiment, a first cover unit 120 for protecting them is disposed around the source grating 12 and others.

The subject table 13 is a table on which the subject H is placed, and can function as a rotating stage for rotating the subject H about the z axis. When a plurality of moire images Mo is captured using the above-described fringe scanning method, a plurality of moire images Mo can be captured while the subject table 13 is rotated to different angles.

In the present embodiment, a controller 19 (see FIG. 1) is formed by a computer in which a central processing unit (CPU), read-only memory (ROM), random-access memory (RAM), an input-output interface, and others (not shown) are connected to a bus. The controller 19 may alternatively be formed as a dedicated control apparatus instead of a general-purpose computer as in the present embodiment. Although not shown, the controller 19 is further provided with appropriate units and devices such as an input unit including an operation unit, an output unit, a storage unit, and a communication unit.

The output unit includes a display unit (not shown) that displays information required to perform various operations of the X-ray Talbot imaging apparatus 1, and generated reconstructed images.

The controller 19 performs overall control over the X-ray Talbot imaging apparatus 1. Specifically, for example, the controller 19 is connected to the X-ray generator 11, and can set a tube voltage, a tube current, an irradiation time, and the like for the X-ray source 11a. Further, for example, the controller 19 can be configured to relay transmission and reception of signals and data between the X-ray detector 16 and the image processing apparatus 2 and others outside.

That is, the controller 19 in the present embodiment functions as a control unit to cause a series of imaging actions to be performed to obtain a plurality of moire images Mo (a single moire image in the case of the Fourier transform method) required to generate reconstructed images of the subject H.

<About Control Apparatus>

As shown in FIG. 4, the X-ray imaging system of the present embodiment includes the X-ray Talbot imaging apparatus 1, the controller 19, the image processing apparatus 2, and a control apparatus 20. The X-ray Talbot imaging apparatus 1, the controller 19, the image processing apparatus 2, and the control apparatus 20 are communicably connected via a bus or the like.

An apparatus in which the control apparatus 20 and the image processing apparatus 2 are combined is an example of a new molding support apparatus of the present invention.

The control apparatus 20 is, for example, a general-purpose computer device (a control PC). However, the control apparatus 20 is not limited to this. A part(s) of the functions of the control apparatus 20 may be provided on a network so that various processing can be executed by exchange of data through communication.

As shown in FIG. 4, the control apparatus 20 includes a central processing unit (CPU) 21, random-access memory (RAM) 22, a storage unit 23, an input unit 24, an external data input unit 25, a display unit 26, a communication unit 27, and others.

The CPU 21 reads various programs such as a system program and processing programs stored in the storage unit 23, expands them in the RAM 22, and executes various types of processing according to the expanded programs.

The RAM 22 functions as a work area for temporarily storing various programs that are read from the storage unit 23 and executable by the CPU 21, input or output data, parameters, and the like in various types of processing executed and controlled by the CPU 21.

The storage unit 23 is formed by a hard disk drive (HDD), a semiconductor nonvolatile memory, or the like. The storage unit 23 stores the above-mentioned various programs and various data.

The input unit 24 includes a keyboard having cursor keys, numeral input keys, various function keys, etc., and a pointing device such as a mouse. The input unit 24 outputs a push-down signal of a key pushed down on the keyboard or an operation signal through the mouse to the CPU 21 as an input signal. The CPU 21 can execute various types of processing based on an operation signal from the input unit 24.

The external data input unit 25 is for inputting data acquired from external devices (including the controller 19) to the X-ray imaging system. As the external data input unit 25, various things can be used, such as a universal serial bus (USB) port and Bluetooth (registered trademark) that allow wired or wireless data transmission and reception to and from an external device, and a drive that reads data from a recording medium corresponding to an external device.

The display unit 26 includes a monitor such as a cathode-ray tube (CRT) or a liquid crystal display (LCD). The display unit 26 displays various screens according to instructions of display signals input from the CPU 21. If a touch panel is used as the display unit 26, the display unit 26 also has a function as the input unit 24.

The communication unit 27 includes a communication interface, and communicates with the external devices on the network. The communication unit 27 may also be used as the external data input unit 25 described above.

The image processing apparatus 2 image-processes output data from the X-ray Talbot imaging apparatus 1, and transmits the image-processed image data to the control apparatus 20. The display unit 26 can display the image data received from the image processing apparatus 2.

Talbot images in the present embodiment refer to images generated by the Talbot effect. As described above, an absorption image, a differential phase image, and a small-angle scattering image are included in “Talbot images” because reconstructed images reconstructed from a moire image(s) Mo are images generated by the Talbot effect described above. Note that the Talbot effect is used as a term that includes not only the Talbot effect by a Talbot interferometer but also the combined effect of the Talbot effect and the Lau effect (obtained due to the G0 grating) by a Talbot-Lau interferometer.

As shown in FIG. 4, the storage unit 23 stores, for example, mold design data 41, molding condition data 42, mapping data 43, corresponding case data 44, a calculation unit 51, an identification unit 52, a detection unit 53, an analysis unit 54, a verification unit 55, a first learner 56, and a second learner 57. The image processing apparatus 2 functions as an image processing unit. The calculation unit 51, the identification unit 52, the detection unit 53, the analysis unit 54, the verification unit 55, the first learner 56, and the second learner 57 are implemented as, for example, programs, and are read and executed by the CPU 21 to function.

(Mold Design Data 41)

The mold design data 41 is data showing a mold design that is a production process of an injection-molded product. The mold design data 41 is a set of information including a plurality of types of items. The items of the mold design data 41 include, for example, the shape and thickness of a mold, the position and shape of a gate, the shape of a runner, the position of a temperature control circuit, and the position of an eject pin, but are not limited to these.

The gate is an inflow port for letting a high-temperature molten composite material flow into a cavity in the mold in the form of the molded product.

The runner is a passage that guides a composite material from a molding machine to the gate.

The temperature control circuit is a circuit that adjusts the temperature of the mold.

The eject pin is a pin for releasing a molded product from the mold.

Injection molding production processes can be mainly categorized into (1) material selection of a composite material used for a molded product, (2) mold design, (3) injection molding, and (4) evaluation of a molded product by a strength test or the like. Work proceeds in this order. The mold design can include confirmation in simulation by computer-aided engineering (CAE).

(Molding Condition Data 42)

The molding condition data 42 is data showing molding conditions of injection molding, which is one of the production processes of an injection-molded product. The molding condition data 42 is a set of information including a plurality of types of items. The items of the molding condition data 42 include, for example, injection speed, mold temperature, molding temperature, holding pressure, injection pressure, and cooling time, but are not limited to these.

The injection speed is the speed at which a composite material is forced into a mold.

The mold temperature is the temperature of the mold.

The molding temperature is the temperature of a screw of the molding machine. The screw is a member that feeds the composite material accumulated in a hopper into the mold through the runner.

The holding pressure is the pressure at the time of holding the pressure in the mold.

The injection pressure is an injection pressure determined from the injection speed, the mold temperature, the molding temperature, and the holding pressure, and can be determined as a measurement value.

The cooling time is the time between holding the pressure and releasing the mold.

A molded product is created through the execution of a kneading step of kneading resin and fiber to produce pellets that are an intermediate product, and an injection molding step of putting the pellets in the molding machine and injecting the composite material into a mold set in the molding machine for molding. At this time, the molding condition data 42 may include information associated with molding such as material information showing materials such as resin and fiber to be kneaded, kneading machine information showing a kneading machine used for kneading, setting conditions and operating data of the molding machine, and data of the mold used in the molding machine. The material information may include the composition ratio of resin and fiber, and physical property parameters of the resin itself and the fiber itself. The physical property parameters include strength indices such as a flexural modulus, flexural strength, and tensile strength, functional indices such as heat resistance, insulation properties, and chemical resistance, and molding indices such as molding shrinkage, viscosity, the melt mass-flow rate (MFR), and the melt volume rate (MVR), for example.

(Mapping Data 43)

The mapping data 43 is data that associates a Talbot feature of a molded product with a specific item of a production process. The Talbot feature is a feature obtained from a Talbot image by the calculation unit 51, and is in any mode. The specific item is, for example, an item that allows adjustment of the Talbot feature, but is not limited to this. By referring to the mapping data 43, an item of a production process required to achieve a desired Talbot feature can be identified. The mapping data 43 is accumulated and updated using, for example, actual measured values of a molded product and a Talbot image.

(Corresponding Case Data 44)

The corresponding case data 44 is data in which information on molded products manufactured in the past is organized on an individual molded product basis. The information on each molded product includes, for example, the mold design of a mold used for injection molding, the molding conditions of injection molding, performance (strength) obtained from a test (Example: a strength test) for the molded product, and Talbot images of the molded product, but is not limited to these.

(Calculation Unit 51)

The calculation unit 51 calculates a Talbot feature of a molded product based on a Talbot image acquired from the X-ray Talbot imaging apparatus 1. Other than the Talbot image itself, the calculation unit 51 can calculate a Talbot feature based on, for example, an image that is image-processed from a Talbot image by the image processing apparatus 2. The image image-processed from the Talbot image may be, for example, an orientation image (described later) that represents orientations of resin and fiber that are the materials of the molded product, but is not limited to this. The image image-processed from the Talbot image is an example of a Talbot image.

(Identification Unit 52)

The identification unit 52 identifies an item that allows adjustment of a Talbot feature from among a plurality of types of items constituting a production process for producing the molded product, using the Talbot feature calculated by the calculation unit 51. Specifically, by referring to the mapping data 43, from a Talbot feature, the identification unit 52 can identify an item of the mold design or an item of the molding conditions that allows adjustment of the Talbot feature. An “item that allows adjustment” means, for example, an item that is a main factor that allows a Talbot feature of interest to be set to a predetermined target value. Thus, the user can determine (or estimate) to which item a Talbot feature obtained from the molded product should be fed back. In other words, the user can know which value of an item of the mold design or an item of the molding conditions to change so as to be able to achieve a desired Talbot feature that contributes to performance improvement of the molded product.

Further, by referring to the corresponding case data 44, using the Talbot features calculated by the calculation unit 51, the identification unit 52 can extract and identify a mold design and molding conditions corresponding to the Talbot features, and a similar mold design and molding conditions.

(Detection Unit 53)

The detection unit 53 detects a molding defect part of a molded product from an orientation image generated by the image processing apparatus 2 when the production process is the mold design for injection molding. Molding defects include, for example, welds, flow marks, jetting, voids, warpage, and sinks, but are not limited to these.

(Analysis Unit 54)

The analysis unit 54 is a functional unit that performs a predetermined simulation. For example, the analysis unit 54 can be CAE. CAE is a technique for simulation and analysis using a prototype on a computer in place of a conventional test or experiment using a prototype. CAE enables, for example, flow analysis of resin in a mold and strength analysis of a molded product. When the production process is the mold design for injection molding, the analysis unit 54 can input mold data based on the mold design and composite material data to perform a flow analysis of the composite material. The mold data is data on a mold used in the molding machine, and includes, for example, information on the material and shape of the mold. The mold data can be acquired from the mold design data 41, for example. The composite material data is data on the composite material, and includes, for example, parameters indicating the characteristics of resin and fiber (Example: viscosity and particle size), and set values such as resin speed and fiber speed. The composite material data can be acquired from the material information in the molding condition data 42, for example.

(Verification Unit 55)

The verification unit 55 compares the analysis results of a flow analysis by the analysis unit 54 with an orientation image generated by the image processing apparatus 2, to verify the validity of the flow analysis. The orientation image generated by the image processing apparatus 2 is desirably in a format that can be compared with the analysis results of the flow analysis.

(First Learner 56)

When the production process is the molding conditions of injection molding, the first learner 56 performs machine learning in which the molding condition data 42 indicating the molding conditions is an input, and Talbot features are an output. The first learner 56 may alternatively perform machine learning in which the molding condition data 42 indicating the molding conditions is an output and Talbot features are an input.

(Second Learner 57)

When the production process is the molding conditions of injection molding, the second learner 57 performs machine learning in which Talbot features are an input and performance data obtained by a test for the molded product is an output. The second learner 57 can alternatively perform machine learning in which Talbot features are an output and performance data obtained by a test for the molded product is an input.

<About Orientation Image>

An orientation image generated by the image processing apparatus 2 is obtained by orientation imaging by the X-ray Talbot imaging apparatus 1. The orientation imaging refers to imaging in which the relative angle between a grating and a sample (a subject: a molded product) is changed by rotating the subject table 13 functioning as a rotating stage. By the orientation imaging, a direction in which a signal value becomes the strongest in each pixel can be determined by arithmetic processing.

In order to obtain an orientation image, first, imaging is performed at different relative angles between the sample and the grating. At least three different relative angles are prepared (Example: 0°, 60°, and 120°). For example, desired relative angles may be provided by rotating the sample with the apparatus side fixed, or by rotating the apparatus side with the sample fixed. The following describes two-dimensional imaging as an example, but can be expanded to three-dimensional imaging.

Next, Talbot images are acquired at each prepared relative angle. Here, an absorption image, a differential phase image, and a small-angle scattering image can be acquired. In the following, the small-angle scattering image or the small-angle scattering image divided by the absorption image is used. The small-angle scattering image divided by the absorption image can be said to be an image in which thickness dependence is canceled in the case of a sample having unevenness. For convenience of explanation, both will be collectively referred to as a “small-angle scattering image”.

Next, the (three or more) small-angle scattering images at the different prepared relative angles are aligned. Here, since the sample has been rotated, an operation to return the images to a predetermined angle is performed.

Finally, fitting is performed with a sine wave for each pixel, extracting fitting parameters. A sine wave graph is a graph in which the horizontal axis is the relative angle between the sample and the grating, and the vertical axis is the small-angle scattered signal value of a pixel. As the fitting parameters, the amplitude, average, and phase of the sine wave are obtained. An image showing amplitude values in the individual pixels is referred to as an “amp image”, an image showing average values in the individual pixels as an “ave image”, and an image showing phases in the individual pixels as a “pha image”. The amp image, the ave image, and the pha image are collectively referred to as an “orientation image”. The way of fitting is not limited to a sine wave. For example, fitting to Equation 1 below may be performed in which an ellipse with largest intensity angle (phase) θ₀, largest intensity a, and lowest intensity b is represented in polar coordinates as position r(θ). In this case, corresponding to the names in sine wave fitting, an image of values (a−b)/2 corresponding to the amplitudes in the individual pixels may be referred to as an “amp image”, an image showing values (a+b)/2 corresponding to the average values in the individual pixels as an “ave image”, and an image showing θ₀ in the individual pixels as a “pha image”. Simply, a major axis a, a minor axis b, and a phase θ₀ of signal intensity may be assigned to each pixel to form an orientation image.

$$\begin{matrix}[ Formula 1 ] & \\ r ( θ ) = \frac{ab}{\sqrt{{b}^{2} {cos}^{2} ( θ - {θ}_{0} ) + {a}^{2} {sin}^{2} ( θ - {θ}_{0} )}} & Equation 1\end{matrix}$$

The image processing apparatus 2 can generate an orientation color map image from the orientation image. The orientation color map image is an image in which the orientations of the resin and the fiber are expressed in colors. For example, by using the amp image as brightness and assigning a color corresponding to angle information of the pha image to each pixel, an orientation color map image can be generated. This orientation color map image can express the degree of orientation and the direction of the resin and the fiber in each pixel. Alternatively, for example, by using the ave image as brightness and assigning a color corresponding to angle information of the pha image to each pixel, an orientation color map image can be generated. This orientation color map image can express the amount and the direction of the resin and the fiber in each pixel.

The image processing apparatus 2 can change the orientation image to an elliptical display image. To make an elliptical display image, a set of the amp image, the ave image, and the pha image can be replaced with a set of the maximum value (ave+amp), the minimum value (ave−amp), pha (phase: the relative angle) of brightness in each pixel. The above is the case of sine wave fitting. If an ellipse is expressed in polar coordinates for fitting, a, b, and θ₀ in each pixel can be directly assigned to the maximum value, the minimum value, and pha of the brightness.

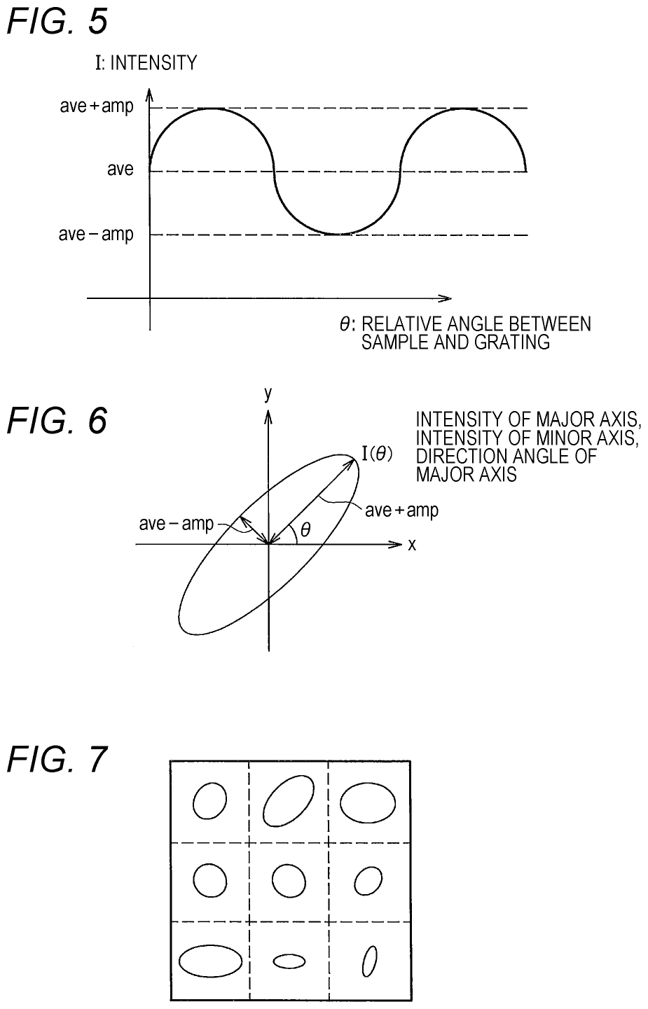

Next, by displaying an ellipse where the major axis is the maximum value, the minor axis is the minimum value, and the angle θ (the relative angle between the sample and the grating) to the x direction (the horizontal axis) is pha in each pixel, an elliptical display image can be generated. For reference, a graph showing the relationship between the brightness (intensity) I and the angle θ in each pixel is shown in FIG. 5, an example of an elliptical display image in a pixel is shown in FIG. 6, and an example of elliptical display images in a plurality of pixels is shown in FIG. 7.

In an elliptical display image, an ellipse closer to a perfect circle indicates non-orientation, and an ellipse closer to a linear shape indicates stronger orientation in the major-axis direction. The area of an ellipse is proportional to an average signal value and indicates the amount of fiber.

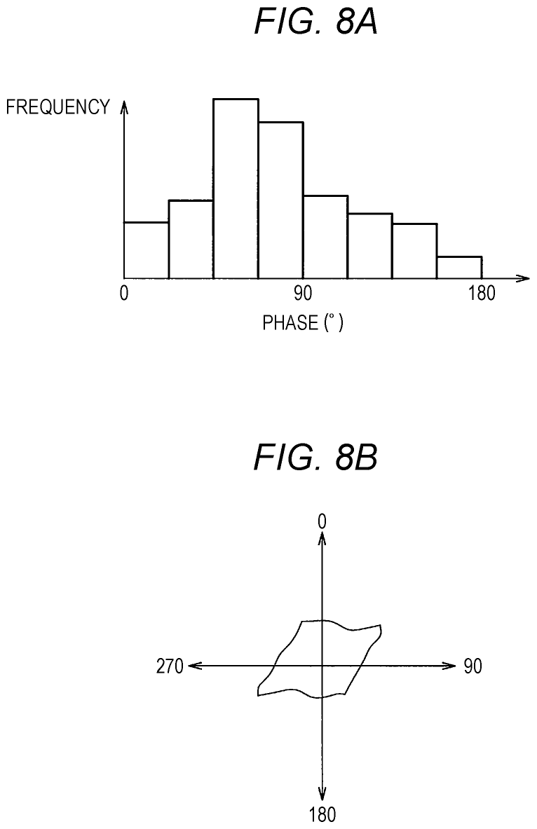

Next, statistical information of the orientation image (hereinafter, referred to as “orientation statistical information”) can be generated in units of a fixed region (for example, a region of 10 pixels×10 pixels in the case of a two-dimensional image). For reference, an example of orientation statistical information of a pha image when a certain region is observed is shown in FIGS. 8A and 8B. FIG. 8A shows a histogram display of the orientation statistical information of the pha image, and FIG. 8B shows a polar coordinate display of the histogram of the pha image.

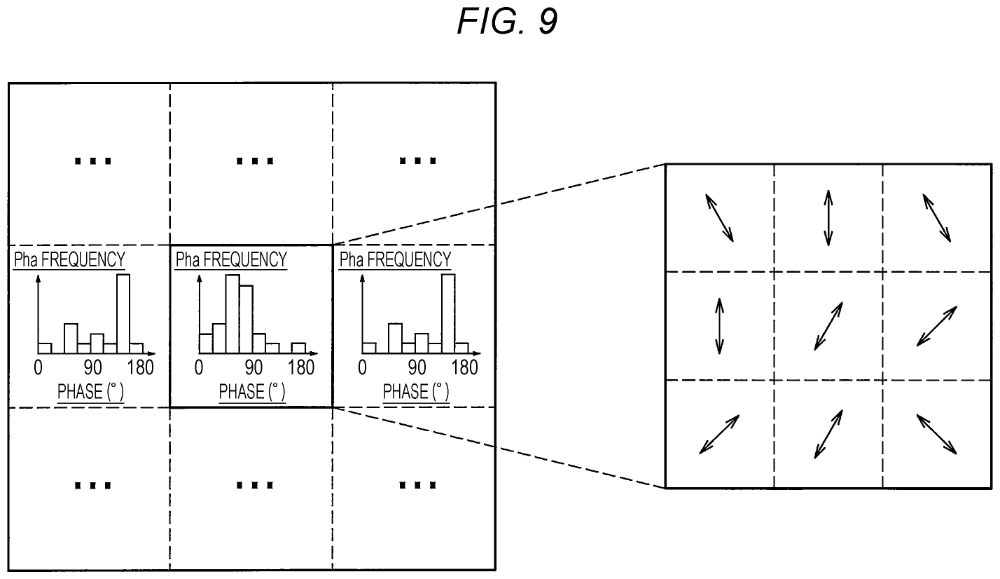

FIG. 9 is an “orientation statistical information image” in which the orientation image (the pha image) is divided into fixed regions (for example, 10 pixels×10 pixels regions), and orientation statistical information is displayed in each fixed region (orientation statistics display).

The orientation statistics display is not limited to the statistical information of the pha image as shown in FIG. 9, and may be display of statistical information of the amp image or the statistical information of the ave image. In the above example, the horizontal axis is the phase of the pha image and the vertical axis is the phase frequency of the pha image. Alternatively, a plurality of pieces of information of the orientation image may be combined. For example, the horizontal axis may be the phase of the pha image, and the vertical axis may be the product of the phase frequency of the pha image and the amp image signal value. As shown in FIG. 9, the orientations of the resin and the fiber represented by double-headed arrows are determined for individual pixels constituting a fixed region.

Further, the image processing apparatus 2 can prepare an orientation image in which the distribution of orientations of the resin and the fiber in a space of a fixed volume is represented by a tensor (orientation tensor). A two-dimensional orientation tensor is defined as in Equation 3. A three-dimensional orientation tensor can be expressed by Equation 2 being extended (not described). First, as shown in Equation 2, a two-dimensional orientation p is expressed by

$$\begin{matrix}[ Formula 2 ] & \\ p = ( \begin{matrix}cos θ \\ sin θ\end{matrix} ) & Equation 2\end{matrix}$$

where θ is the angle to the x-axis.

When n two-dimensional orientations exist in a certain region, the average state of the orientations in that region can be defined as a two-dimensional orientation tensor A.

$$\begin{matrix}[ Formula 3 ] & \\ A = ( \begin{matrix}〈 {p}_{1} {p}_{1} 〉 & 〈 {p}_{1} {p}_{2} 〉 \\ 〈 {p}_{2} {p}_{1} 〉 & 〈 {p}_{2} {p}_{2} 〉\end{matrix} ) = ( \begin{matrix}\frac{1}{n} \sum {p}_{1} {p}_{1} & \frac{1}{n} \sum {p}_{1} {p}_{2} \\ \frac{1}{n} \sum {p}_{1} {p}_{2} & \frac{1}{n} \sum {p}_{2} {p}_{2}\end{matrix} ) & Equation 3\end{matrix}$$

Here, the sum of diagonal elements of the orientation tensor is one (trace A=1). p1 and p2 in Equation 3 are the values of p when θ in Equation 2 takes different values.

Talbot features calculated by the calculation unit 51 based on Talbot images include, for example, the following. First, an orientation image (an amp image, an ave image, and a pha image) itself can be used as Talbot features. When an image is used as Talbot features, the same number of inputs as pixels are required. Thus, it is desirable to use a binned image to limit input information.

If a position correlated with strength (Example: a position where a weld is likely to form, or a position where a void is likely to form), in particular, has been determined in a molded product to be a subject, only orientation image signal values (amp, ave, and pha) in an image region of interest (ROI) including the position may be used as Talbot features.

Further, an eccentricity ecc may be used as a Talbot feature. If σ₁=ave+amp (corresponding to the maximum value of the small angle signal value) and σ₂=ave−amp (corresponding to the minimum value of the small angle signal value) are calculated using the signal values amp and ave obtained from the orientation image,

$$\begin{matrix}[ Formula 4 ] & \\ ecc = \sqrt{\frac{{σ}_{1}^{2} - {σ}_{2}^{2}}{{σ}_{1}^{2}}} & Equation 4\end{matrix}$$

An image showing ecc in each pixel may be included in the orientation image as an “ecc image”.

### Example 1: Feedback to Mold Design (Part 1)

For example, the control apparatus 20 can detect a weld of a molded product and provide feedback to the mold design to prevent the formation of the weld.

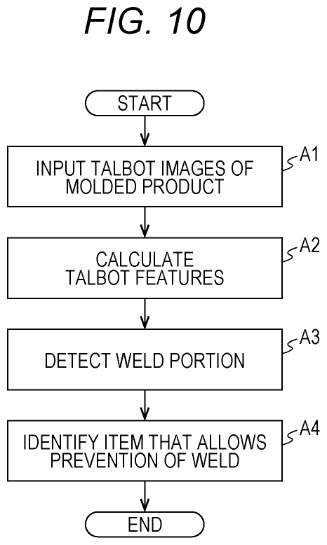

As shown in FIG. 10, first, the CPU 21 of the control apparatus 20 inputs Talbot images of the molded product through the input unit 24 or the external data input unit 25 (step A1). Specifically, as the Talbot images, an amp image and a pha image of the molded product are input.

Next, the CPU 21 calculates Talbot features by the calculation unit 51 (step A2). Specifically, the amp image is binarized. This is because the amp signal value at a weld portion becomes large, so that the weld portion can be highlighted. The pha image is binarized by creating a histogram to obtain a mode value and an average value, and determining whether or not the pha value is within the range of (the mode value±the average value). This is because the phase is concentrated in a specific direction at a weld portion, so that the weld portion can be highlighted. The calculation unit 51 calculates the binarized amp image and the binarized pha image as Talbot features.

Next, the CPU 21 detects a weld portion from the Talbot features by the detection unit 53 (step A3). At this time, the image processing apparatus 2 can create an image in which an image corresponding to the weld portion detected by the detection unit 53 is overlaid on an orientation image (for example, the amp image or the ave image), and display it on the display unit 26. Further, a strength average at an estimated weld portion in the amp image may be defined as a Talbot feature referred to as a weld strength and displayed.

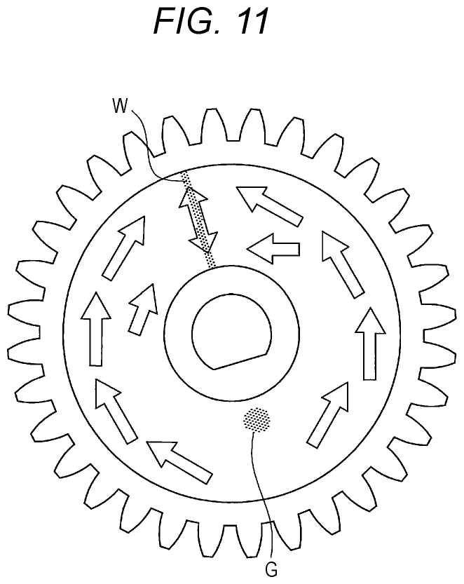

For example, as shown in FIG. 11, when an orientation color map image is generated for a gear made of resin as a molded product, it can be confirmed that resin injected from a gate (symbol G) flows in two directions, and the flows of the resin meet on the side opposite to the gate with respect to the center of the gear, forming a weld oriented radially (symbol W). In the orientation color map image, the orientations of the resin are displayed in different colors. In FIG. 11, however, the orientations of the resin are represented by white arrows corresponding to the colors for convenience of illustration. The detection unit 53 can detect a weld portion from the orientation color map image.

Returning to FIG. 10, finally, the CPU 21 identifies an item that allows prevention of the weld from among the items of the mold design data 41 by the identification unit 52 using the detected weld portion (or the binarized amp image and the binarized pha image) (step A4). Specifically, the identification unit 52 refers to the mapping data 43 and identifies an item that allows prevention of the weld.

The processing of FIG. 10 can detect a weld of a molded product using Talbot features obtained from an orientation image, and provide feedback to the mold design so as to prevent the formation of the weld. For example, the adjustment of the mold design such as the adjustment of the gate position, the adjustment of the runner, and the provision of a resin well or the like in the mold can be facilitated. In addition, the verification of the effect after mold design improvement can be facilitated. As a result, performance improvement of the molded product can be supported.

Furthermore, weld emphasis processing may be implemented by preparing a learning set in which an image containing a weld is annotated with a weld portion, and generating and utilizing a learner for weld emphasis. Moreover, the correlation between a signal value at a weld portion and a strength in a tensile test can be acquired in advance to estimate the strength from the signal value at the weld portion.

### Example 2: Feedback to Mold Design (Part 2)

For example, the control apparatus 20 can provide feedback to a mold design so as to improve the accuracy of the mold design by CAE validation.

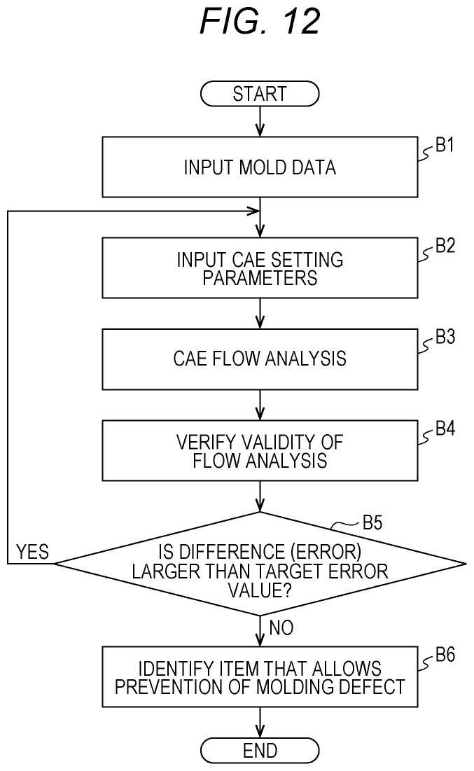

As shown in FIG. 12, first, the CPU 21 of the control apparatus 20 inputs mold data indicating a mold of a desired shape from the mold design data 41 by the input unit 24 or the external data input unit 25 (step B1).

Next, the CPU 21 inputs CAE setting parameters by the input unit 24 or the external data input unit 25 (step B2). The setting parameters include, for example, material information (composition ratio, physical property values, etc.) of resin and fiber of a composite material, resin speed, etc., but are not limited to these.

Next, the CPU 21 executes a CAE flow analysis by the analysis unit 54 (step B3). The analysis results of the flow analysis are, for example, those shown in FIG. 13, but are not limited to these. FIG. 13 shows orientations (double-headed arrows) of resin in individual CAE meshes in a case where resin data is poured into mold data of a mold design for producing a gear molded product. Nearly vertical orientations in central two columns of meshes indicate orientations of a weld formed in the radial direction of the gear. Nearly horizontal orientations in left and right two columns of meshes indicate orientations of the resin flowing into the weld.

Next, the CPU 21 compares, by the verification unit 55, the analysis results of the flow analysis with an orientation image of the corresponding molded product (gear) generated in advance by actual measurement (generated using the mold indicated by the mold data in step B1), to verify the validity (validation) of the flow analysis (step B4). Here, the orientation image is equivalent to the orientation image described in Example 1, and is an image that allows the detection of a molding defect such as a weld. The orientation image is processed to have a format that can be compared with the analysis results of the flow analysis, and will be referred to as an “output for flow analysis comparison”. Details of the derivation of an output for flow analysis comparison will be described later.

If the difference (error) between the analysis results of the flow analysis and the output for flow analysis comparison is larger than a target error value (Yes in step B5), it means that the flow analysis is not valid, and the process returns to step B2 to repeat the processing. On the other hand, if the difference is smaller than or equal to the target error value (No in step B5), it means that the flow analysis is valid, and the input mold data and setting parameters are used. An example of the calculation of the difference (error) will be described later.

Finally, the CPU 21 identifies, by the identification unit 52, an item that allows the prevention of a molding defect such as a weld from among the items of the mold design data 41, using at least either the output for flow analysis comparison or the analysis results of the flow analysis (step B6). Specifically, the identification unit 52 refers to the mapping data 43 and identifies an item that allows the prevention of the molding defect.

The processing of FIG. 12 can improve the accuracy of a mold design by CAE and provide feedback to the mold design so as to prevent a molding defect, in addition to the effects of Example 1.

In the processing of FIG. 12, the orientation image is processed to match the CAE analysis results. On the contrary, the CAE analysis results may be processed to match the format of the orientation image (to match the degrees of orientation and the amounts of fiber in the individual pixels that can be extracted from the Talbot images).

The analysis unit 54 can perform calculations such as structural analysis and simulation strength prediction after the flow analysis regardless of the result of the verification unit 55.

[Derivation of Output for Flow Analysis Comparison (Part 1: Comparison of Principal Orientations)]

If CAE flow analysis is performed in three dimensions, processing to contract analysis results to a two-dimensional plane imaged is performed. Then, by extracting main orientation components of an orientation tensor and averaging main orientation components extracted in a direction perpendicular to the two-dimensional plane imaged, a main orientation of the CAE analysis results can be compared with a main orientation of an orientation image as actual measured values, and the orientation angles of resin and fiber can be compared between the CAE analysis results and the orientation image. Here, the main orientation components are averaged as a vector.

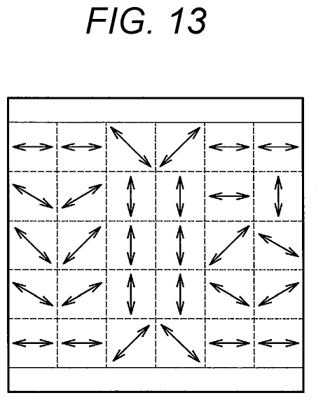

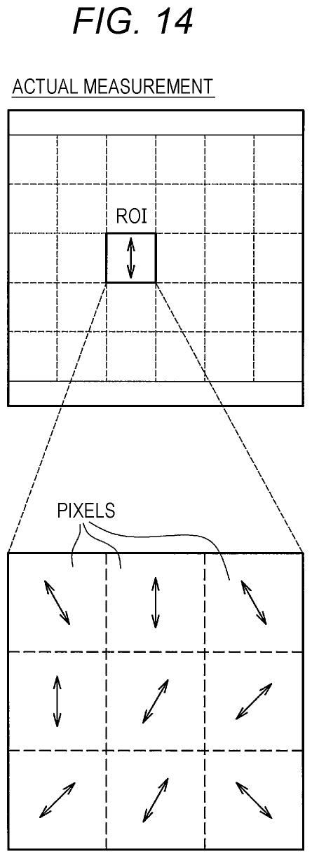

Next, the ROI size of the orientation image is determined according to the mesh shape of the CAE flow analysis (which determines the flow and fiber directions in the individual meshes). Next, a value obtained by averaging angles is extracted for each ROI of a pha image of the orientation image. At this time, the angles are not simply added but addition-processed as a vector. For example, as shown in FIG. 14, a ROI that is a collection of a plurality of pixels (nine (=3×3) pixels in FIG. 14) of a pha image as actual measured values is determined to match the CAE mesh size. Angles (orientations) in individual pixels constituting a ROI are averaged to extract an angle (orientation) in each ROI. The extracted angles in the individual ROIs can be compared with the angles (orientation angles) in the individual CAE meshes.

The above is an example in which the mesh of an orientation image is matched with the mesh of CAE. Conversely, the mesh structure of CAE may be matched with the mesh structure of a Talbot image. If this analysis is performed with a specific shape defined by a JIS standard or the like, it is desirable to prepare a structure and a mesh structure for the JIS standard on the CAE side in advance to eliminate mesh matching with a Talbot image.

As a method of comparing the analysis results of flow analysis and actual measurement (an orientation image), for example, there is a method using a comparison viewer that displays the analysis results of flow analysis and actual measured values side by side on the same screen, showing a portion(s) (a mesh(es)) having large difference by a heat map. For example, as shown in FIG. 15, meshes satisfying ABS(θsim−θmes)>θthr can be highlighted (shaded in FIG. 15) where θsim is an angle in each mesh extracted by CAE flow analysis, θmes is an angle in each mesh extracted from an actual measured value, and θthr is a predetermined threshold value. Portions having different orientations can be made clear. In the comparison viewer, it is desirable that processing performed on one side of the analysis results of flow analysis and actual measurements is applied to the other side synchronously. For example, if an image on one side is scaled up or down or translated, it is desirable that an image on the other side is also scaled up or down or translated.

Further, the comparison viewer may display errors between the analysis results of CAE flow analysis and actual measured values in the individual meshes as a statistic (an average, a median, a deviation, or the like) obtained by statistical processing of them. The error can be calculated as Equation 5 below where an angle (orientation) in each mesh is considered as a vector value. Specifically, the vector values of the analysis results of CAE flow analysis are (cos(θsim), sin(θsim)), and the vector values of actual measured values are (cos(θmes), sin(θmes)).

$$\begin{matrix} [ Formula 5 ] & \\ Error = \sqrt{{( cos ( {θ}_{sim} ) - cos ( {θ}_{mes} ) )}^{2} + {( sin ( {θ}_{sim} ) - sin ( {θ}_{mes} ) )}^{2}} & Equation 5\end{matrix}$$

The verification unit 55 can determine the validity of the flow analysis based on whether this error is larger than the target error value or not.

[Derivation of Output for Flow Analysis Comparison (Part 2: Comparison of Orientation Tensors)]

In place of the above-described comparison of only orientation angles, comparison of orientation tensor equivalents can be performed in each analysis region. The explanation of this follows Reference 1 (Directional x-ray dark-field imaging of strongly ordered systems, PHYSICAL REVIEW B 82, 214103 (2010)).

According to Reference 1, a two-dimensional scattering function μ(x, y) of a scatterer spread in the x- and y-axes, when considered by a Gaussian function model, can be expressed as Equation 6 below.

$$\begin{matrix}[ Formula 6 ] & \\ μ ( x , y ) = \frac{1}{2 {πσ}_{1} {σ}_{2}} exp ( - ( {ax}^{2} + bxy + {cy}^{2} ) ) ) \\ a = \frac{{cos}^{2} {θ}_{0}}{2 {σ}_{1}^{2}} + \frac{{sin}^{2} {θ}_{0}}{2 {σ}_{2}^{2}} \\ b = sin {θ}_{0} cos {θ}_{0} ( - \frac{1}{2 {σ}_{1}^{2}} + \frac{1}{2 {σ}_{2}^{2}} ) \\ c = \frac{{sin}^{2} {θ}_{0}}{2 {σ}_{1}^{2}} + \frac{{cos}^{2} {θ}_{0}}{2 {σ}_{2}^{2}} & Equation 6\end{matrix}$$

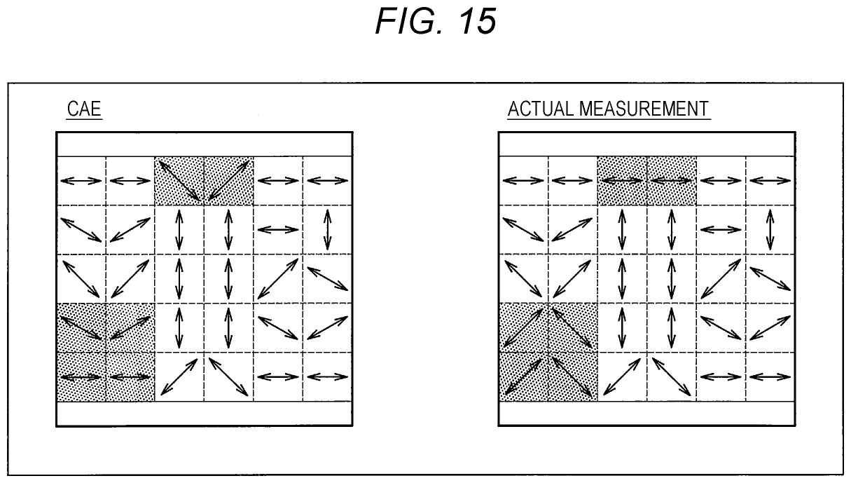

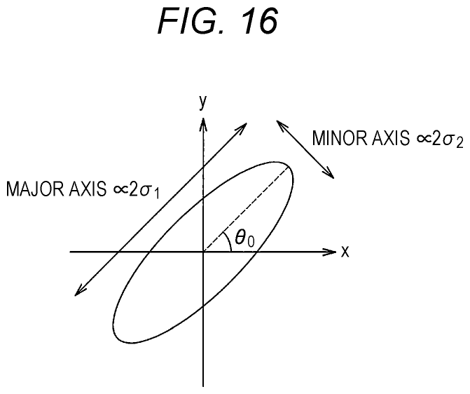

Here, σ₁ and σ₂ are indices indicating the anisotropy of scattering in magnitude-specific directions of principal-axis components of a Gaussian function. For a scatterer such as fiber, the values of σ₁ and σ₂ are large. Therefore, the ratio of σ₁ and σ₂ is an index of anisotropy. As shown in FIG. 16, when a contour line of a scattering function is drawn, the ratio between the major axis and the minor axis is 2σ₁: 2σ₂, and can be an index of anisotropy. θ₀ shown in FIG. 16 is an angle formed by σ₁ and the x-axis. For example, if the distribution of fiber orientations spread in an x-y space includes many inclined 45° to the x-axis, θ₀=45.

Let tensor representation U of a scattering function be Equation 7 below. a, b, and c in Equation 7 represent components of a tensor.

$$\begin{matrix}[ Formula 7 ] & \\ U = ( \begin{matrix}a & b \\ b & c\end{matrix} ) & Equation 7\end{matrix}$$

On the other hand, a small-angle scattering image obtained by Talbot image capturing can be expressed by Equation 8 below in terms of the relative angle θ between the grating angle and a scatterer. k is a constant determined by the grating period.

[Formula 8]

V(θ)=exp(−k(σ₁²+σ₂²)exp(−k(σ₁²−σ₂²)cos(2(θ−θ₀)−π) Equation 8

In order to improve the visibility of Equation 8, logarithmic transformation is performed and a negative sign is added to obtain Equation 9.

[Formula 9]

SC(θ)=−InV(θ)=k(σ₁²+σ₂²)−k(σ₁²−σ₂²)cos(2(θ−θ₀)) Equation 9

By a plurality of times of imaging at different relative angles between a sample and a grating in Talbot image capturing, the angle θ₀ at which the maximum value (max), the minimum value (min), and SC(θ) become the largest can be calculated (see Equation 10) (similar to the procedure for extracting an orientation image described above).

$$\begin{matrix}[ Formula 10 ] & \\ max = SC ( {θ}_{0} ) = 2 k {σ}_{2}^{2} \\ min = SC ( {θ}_{0} + \frac{1}{2} π ) = 2 k {σ}_{1}^{2} & Equation 10\end{matrix}$$

Next, the tensor representation U of a two-dimensional scattering function is determined from information obtained from the Talbot image capturing as in Equation 11 below.

$$\begin{matrix} [ Formula 11 ] & \\ U = k ( \begin{matrix}\frac{{cos}^{2} {θ}_{0}}{max} + \frac{{sin}^{2} {θ}_{0}}{min} & sin {θ}_{0} cos {θ}_{0} ( \begin{matrix}- \frac{1}{max} + \\ \frac{1}{min}\end{matrix} ) \\ sin {θ}_{0} cos {θ}_{0} ( \begin{matrix}- \frac{1}{max} + \\ \frac{1}{min}\end{matrix} ) & \frac{{sin}^{2} {θ}_{0}}{max} + \frac{{cos}^{2} {θ}_{0}}{min}\end{matrix} ) & Equation 11\end{matrix}$$

The two-dimensional scattering function expresses the spatial distribution of a scattered image. Therefore, the two-dimensional scattering function is considered to be a counterpart of the orientation tensor of the flow analysis for comparison. Here, the sum of diagonal elements of the orientation tensor of the flow analysis is defined as one. Therefore, Unorm obtained by normalizing the tensor representation U of the two-dimensional scattering function by diagonal elements is defined as in Equation 12 below.

$$\begin{matrix} [ Formula 12 ] & \\ {U}_{norm} = {k}_{norm} ( \begin{matrix}\frac{{cos}^{2} {θ}_{0}}{min} + \frac{{sin}^{2} {θ}_{0}}{max} & sin {θ}_{0} cos {θ}_{0} ( \begin{matrix}- \frac{1}{min} + \\ \frac{1}{max}\end{matrix} ) \\ sin {θ}_{0} cos {θ}_{0} ( \begin{matrix}- \frac{1}{min} + \\ \frac{1}{max}\end{matrix} ) & \frac{{sin}^{2} {θ}_{0}}{min} + \frac{{cos}^{2} {θ}_{0}}{max}\end{matrix} ) \\ {k}_{norm} = \frac{k}{min} + \frac{k}{max} & Equation 12\end{matrix}$$

The analysis unit 54 represents the analysis results of the CAE flow analysis by the tensor of the two-dimensional scattering function normalized by the diagonal elements, and represents the actual measured values using the orientation image by the tensor of the two-dimensional scattering function normalized by the diagonal elements. The verification unit 55 can compare the two tensors with each other and verify the validity of the flow analysis (see step B4 in FIG. 12).

### Example 3: Feedback to Molding Conditions

A Talbot image of a molded product can be said to be an image that visualizes parameters such as the fluidity and fiber orientation of a composite material, which have been a black box in a molding process. For example, the control apparatus 20 can provide feedback to molding conditions so as to achieve a target performance value of a molded product by machine learning using a Talbot image of the molded product.

In order to produce a molded product of a composite material, it is necessary to go through a kneading step of kneading resin and fiber to produce pellets that are an intermediate product, and an injection molding step of putting the pellets in a molding machine and injecting resin into a mold set in the molding machine for molding. Therefore, by Talbot image capturing of the pellets as the intermediate product and the molded product, internal orientation information is visualized to collect information. After that, tests such as a strength test and a dimensional test are performed to measure tensile strength, bending strength, warpage, etc. to collect information. Further, information associated with molding such as material information at the time of kneading (composition ratio and parameters of the material itself), kneader information at the time of kneading, and setting conditions, operating data, and mold data of molding machine information at the time of molding (the molding condition data 42) is also collected. The storage unit 23 stores these collected information pieces.

[Determination of Optimum Molding Conditions by Machine Learning (Part 1)]

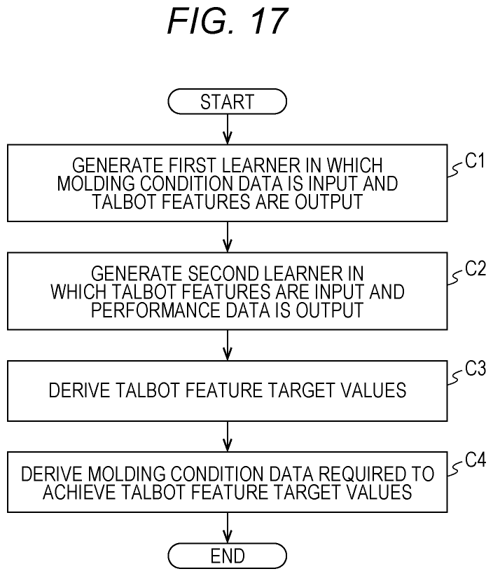

As shown in FIG. 17, first, the CPU 21 of the control apparatus 20 generates the first learner 56 that performs machine learning in which the molding condition data 42 indicating the molding conditions is an input and Talbot features of the molded product are an output (step C1). The molding condition data 42 to be an input can include, for example, information indicating molding conditions themselves, material information, kneading conditions, and Talbot features of pellets, but is not limited to these.

Next, the CPU 21 generates the second learner 57 that performs machine learning in which Talbot features of the molded product are an input and performance data obtained by tests for the molded product is an output (step C2). The performance data is data indicating strength characteristics of the molded product obtained by tests such as a strength test. For the purpose of improving learning accuracy, it is desirable to select a plurality of types of Talbot features of the molded product used as an input (Example: Talbot features obtained by imaging the molded product at different angles).

Next, the CPU 21 derives, by the identification unit 52, target values of the Talbot features (Talbot feature target values) required to achieve a target strength (performance) (step C3). Specifically, first, the identification unit 52 scatters one or a plurality of types of Talbot features of different values within a certain range, and causes the second learner 57 to estimate the strength (performance data) each time the Talbot features are input. Next, the identification unit 52 sets Talbot features set when the strength estimated by the second learner 57 is close to the target strength (the difference between the estimated strength and the target strength is smaller than or equal to a predetermined value), as Talbot feature target values.

Finally, the CPU 21 derives, by the identification unit 52, the molding condition data 42 required to achieve the Talbot feature target values (step C4). Specifically, first, the identification unit 52 scatters one or a plurality of types of molding condition data 42 of different values (molding conditions, material information, kneading conditions, and Talbot features of pellets) within a certain range, and causes the first learner 56 to estimate the Talbot features of the molded product each time the molding condition data 42 is input. Next, the identification unit 52 sets the molding condition data 42 set when the Talbot features estimated by the first learner 56 are close to the Talbot feature target values (the differences between the estimated Talbot features and the Talbot feature target values are smaller than or equal to a predetermined value), as the optimum molding condition data 42.

The processing of FIG. 17 can provide feedback to the molding conditions for achieving a target value of the performance of the molded product.

[Determination of Optimum Molding Conditions by Machine Learning (Part 2)]

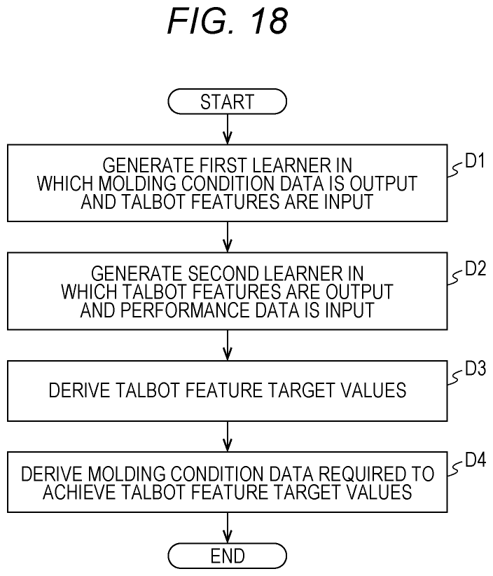

As shown in FIG. 18, first, the CPU 21 of the control apparatus 20 generates the first learner 56 that performs machine learning in which the molding condition data 42 indicating the molding conditions is an output and Talbot features of the molded product are an input. (step D1). The molding condition data 42 to be an output can include, for example, information indicating molding conditions themselves, material information, kneading conditions, and Talbot features of pellets, but is not limited to these. For the purpose of improving learning accuracy, it is desirable to select a plurality of types of Talbot features of the molded product used as an input (Example: Talbot features obtained by imaging the molded product at different angles).

Next, the CPU 21 generates the second learner 57 that performs machine learning in which Talbot features of the molded product are an output and performance data obtained by tests for the molded product is an input (step D2). The performance data is data indicating strength characteristics of the molded product obtained by tests such as a strength test.

Next, the CPU 21 derives, by the identification unit 52, target values of the Talbot features (Talbot feature target values) required to achieve a target strength (performance) (step D3). Specifically, the identification unit 52 inputs a target value of strength to the second learner 57 and causes the second learner 57 to estimate the Talbot feature target values.

Finally, the CPU 21 derives, by the identification unit 52, the molding condition data 42 required to achieve the Talbot feature target values (step D4). Specifically, the identification unit 52 inputs the estimated Talbot feature target values to the first learner 56, and causes the first learner 56 to estimate the molding condition data 42. The identification unit 52 sets the estimated molding condition data 42 as the optimum molding condition data 42.

The processing of FIG. 18 can provide feedback to the molding conditions for achieving a target value of the performance of the molded product.

[Detection of Void]

In the manner of Example 1, for example, the control apparatus 20 can detect a void in a molded product and, as a result, can provide feedback to the mold design so as to prevent the formation of the void.

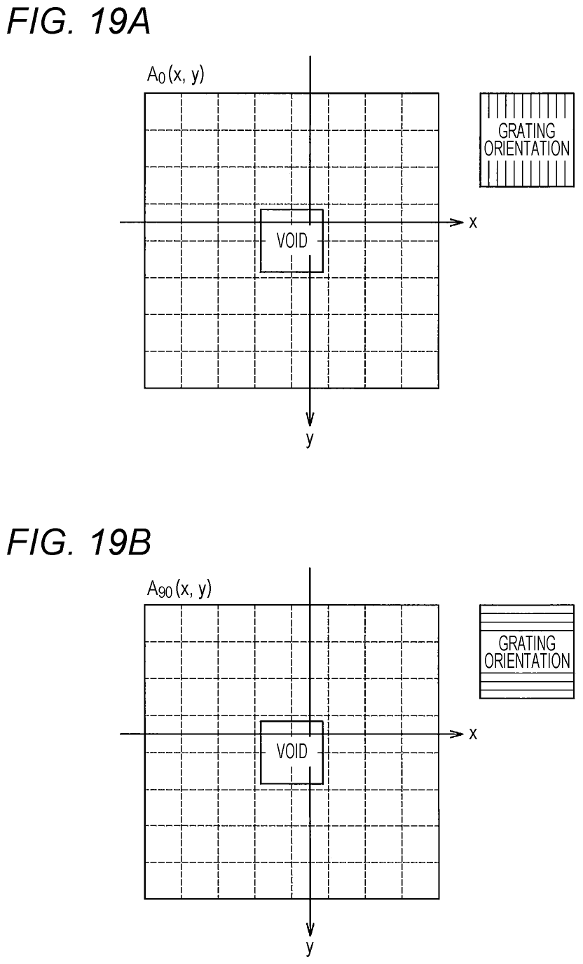

A void portion can be extracted relatively easily by using differential phase images obtained as Talbot images. First, the control apparatus 20 acquires a 0° image (A₀(x, y)) and a 90° image (A₉₀(x, y)) to a subject as differential phase images. FIG. 19A shows a display example of the image (A₀(x, y)) of a region containing a void. For the image (A₀(x, y)), the grating orientation is the vertical direction. FIG. 19B shows a display example of the image (A₉₀(x, y)) of the region containing the void. For the image (A₉₀(x, y)), the grating orientation is the horizontal direction.

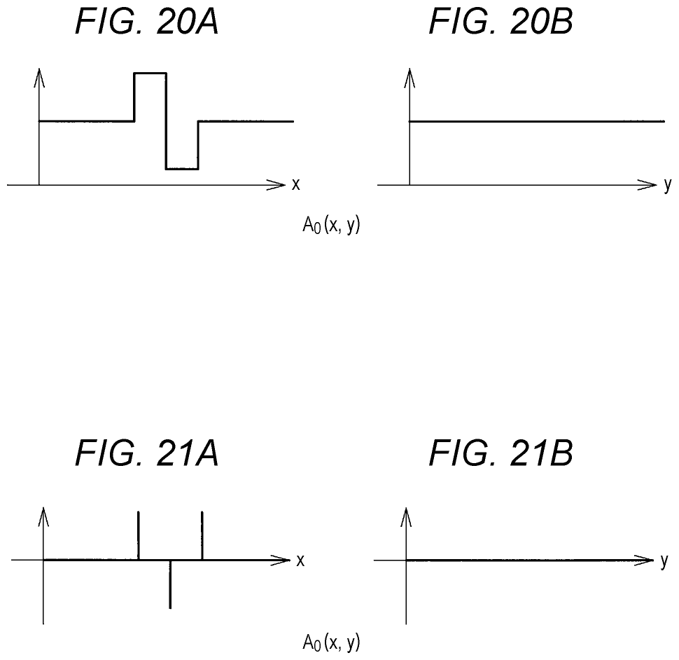

Next, the calculation unit 51 of the control apparatus 20 performs differentiation on the image (A₀(x, y)) in the horizontal direction (the x direction) orthogonal to the grating orientation, so that the contours of a portion where a signal of the differential phase image changes greatly can be extracted. As shown in a graph of a differential phase signal in the x direction in FIG. 20A, a large amplitude value change is exhibited in the horizontal direction (the x direction) at the void portion. As shown in a graph of a differential phase signal in the y direction in FIG. 20B, there is no amplitude value change in the vertical direction (the y direction) parallel to the grating orientation even at the void portion.

Thus, when differentiation is performed in the horizontal direction (the x direction) in the graph of FIG. 20A, there are amplitude values indicating the contours of the void as shown in a graph of the value of change in the differential phase signal in the x direction in FIG. 21A. As shown in a graph of the value of change in the differential phase signal in the y direction in FIG. 21B, even if differentiation is performed in the vertical direction (the y direction), no amplitude values occur.

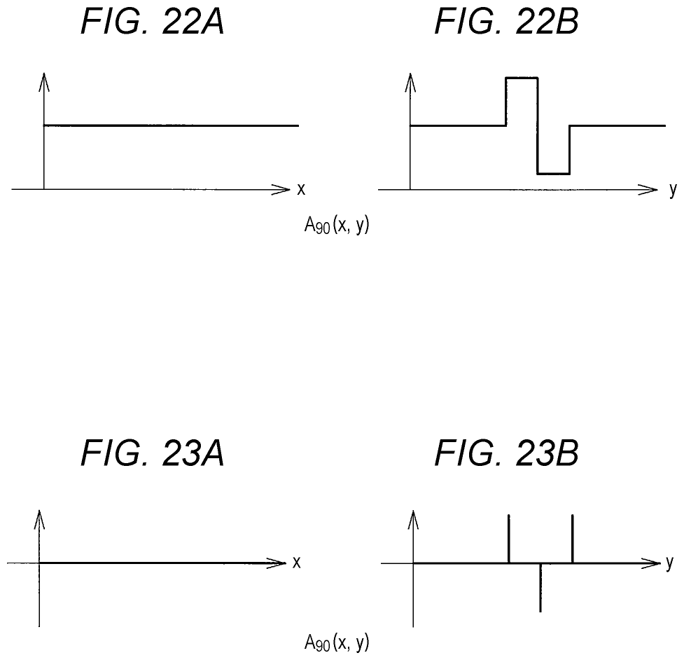

Further, the calculation unit 51 of the control apparatus 20 performs differentiation on the image (A₉₀(x, y)) in the vertical direction (the y direction) orthogonal to the grating orientation, so that the contours of a portion where a signal of the differential phase image changes greatly can be extracted. As shown in a graph of a differential phase signal in the y direction in FIG. 22B, a large amplitude value change is exhibited in the vertical direction (the y direction) at the void portion. As shown in a graph of a differential phase signal in the x direction in FIG. 22A, there is no amplitude value change in the horizontal direction (the x direction) parallel to the grating orientation even at the void portion.

Thus, when differentiation is performed in the vertical direction (the y direction) in the graph of FIG. 22B, there are amplitude values indicating the contours of the void as shown in a graph of the value of change in the differential phase signal in the y direction in FIG. 23B. As shown in a graph of the value of change in the differential phase signal in the x direction in FIG. 23A, even if differentiation is performed in the horizontal direction (the x direction), no amplitude values occur.

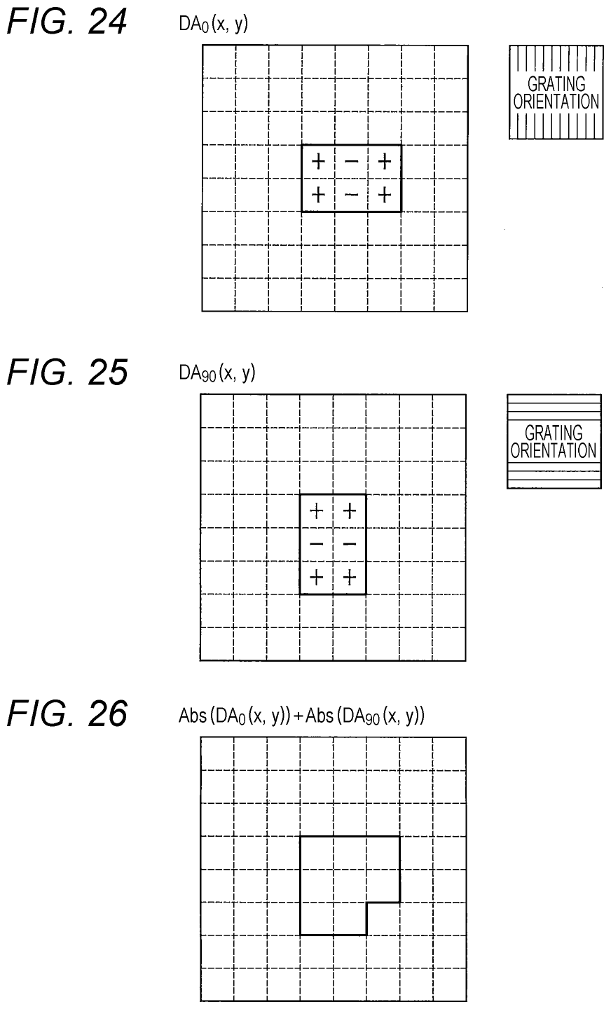

Images obtained by differentiating (double differentiating) the 0° image (A₀(x, y)) and the 90° image (A₉₀(x, y)) to the subject are referred to as an image (DA₀(x, y)) and an image (DA₉₀(x, y)), respectively. FIG. 24 shows a display example of the image (DA₀(x, y)) of the region containing the void. For the image (DA₀(x, y)), the grating orientation is the vertical direction. FIG. 25 shows a display example of the image (DA₉₀(x, y)) of the region containing the void. For the image (DA₉₀(x, y)), the grating orientation is the horizontal direction. “+” and “−” shown in FIGS. 24 and 25 indicate signs of the amplitude values.

The calculation unit 51 of the control apparatus 20 determines the absolute values of the amplitude values shown in the image (DA₀(x, y)), and determines the absolute values of the amplitude values shown in the image (DA₉₀(x, y)). Further, the image processing apparatus 2 generates a composite image (abs(DA₀(x, y))+abs(DA₉₀(x, y))) of the image (DA₀(x, y)) from which the absolute values of the amplitude values have been taken, and the image (DA₉₀(x, y)) from which the absolute values of the amplitude values have been taken. FIG. 26 shows a display example of the composite image.

The calculation unit 51 can detect a region where a signal value shown in a composite image is larger than or equal to a predetermined value as a void. At this time, the number of pixels corresponding to the void, the size of the void when pixels corresponding to the void are continuous, or the like can be used as a Talbot feature. The identification unit 52 can identify an item that allows the improvement of a void from among the items constituting the mold design by referring to the mapping data 43, for example.

Further, it is possible to cause the calculation unit 51 to perform machine learning with a Talbot image annotated with a portion of a void or a crack as a learning set, so that the calculation unit 51 functions as a void detector.

<About Filler>

A filler (sensitizer) is desirably added to a composite material for injection molding. When a molded product containing a filler is imaged by the X-ray Talbot imaging apparatus 1, a Talbot image in which the flow of resin and fiber is clear can be acquired. For example, if a final product is formed only of resin, it is difficult to visualize the resin flow in a Talbot image. At a development stage, by adding a small amount of filler to resin, the flow of the resin can be visualized, and can be fed back to a production process. At this time, the filler added desirably has little influence on the resin flow.

For example, the filler desirably at least (1) has a grain size equivalent to the grating period of the X-ray Talbot imaging apparatus 1, or (2) has an anisotropic shape, or (3) has a fibrous form, or (4) has a fiber diameter equivalent to the grating period when in a fibrous form. The grain size and the fiber diameter of (1) and (4) are desirably in the range of 100 nm to some tens of μm in which the sensitivity of the X-ray Talbot imaging apparatus is high.

### SUMMARY

According to the present embodiment, by using a Talbot image of a molded product of a composite material, Talbot features indicating the flow of resin, the orientation of fiber, etc. can be provided as information to make objective judgements on a production process of the molded product. Thus, feedback to the production process based on the Talbot features can be facilitated.

Consequently, performance improvement of the molded product can be supported.

Further, using Talbot features obtained from an orientation image can facilitate feedback to a mold design that allows the improvement of a molding defect part.

Furthermore, the accuracy of a mold design by flow analysis can be improved.

In addition, when molding condition data is input and performance data is output by machine learning using Talbot features, feedback to molding conditions to achieve a target value of the performance of a molded product can be facilitated.

Further, when performance data is input and molding condition data is output by machine learning using Talbot features, feedback to molding conditions to achieve a target value of the performance of a molded product can be facilitated.

Furthermore, using a filler allows the acquisition of a Talbot image in which the flow of resin and fiber is clear.

### MODIFICATION

(a): Although the present embodiment has been described using the injection-molded product, the present invention is also applicable to a press-molded product, for example.

(b): A technique in which various techniques described in the present embodiment are appropriately combined can also be provided.

(c): Although the present embodiment has been described using the examples of two-dimensional images, the present invention is also applicable to a case where a Talbot image is expanded to a three-dimensional image and is compared with CAE that is also three-dimensional data without being changed.

(d): Although the present embodiment has described the technique of generating an orientation image from Talbot images, the technique of generating an orientation image is not limited to this.

Although embodiments of the present invention have been described and illustrated in detail, the disclosed embodiments are made for purposes of illustration and example only and not limitation. The scope of the present invention should be interpreted by terms of the appended claims.

What is claimed is:

1. A molding support apparatus that supports production of a molded product of a composite material, the apparatus comprising:
a hardware processor that calculates a Talbot feature of the molded product, based on a Talbot image acquired from an X-ray Talbot imaging apparatus that images the molded product, and
identifies, using the calculated Talbot feature, an item that allows adjustment of the Talbot feature from among a plurality of types of items constituting a production process for producing the molded product.

2. The molding support apparatus according to claim 1, wherein
the production process is a mold design for injection molding,
the molding support apparatus further comprises:
an image processor that generates an orientation image representing orientation of resin that is a material of the molded product from the Talbot image, and
the hardware processor detects a molding defect part of the molded product from the orientation image, and
identifies an item that allows improvement of the molding defect part from among items constituting the mold design.

3. The molding support apparatus according to claim 1, wherein
the production process is a mold design for injection molding,
the hardware processor inputs mold data based on the mold design and composite material data and performs a flow analysis of the composite material in injection molding, and
the molding support apparatus further comprises:
an image processor that generates, from the Talbot image, an orientation image that represents orientation of resin and fiber that are materials of the molded product, and has a format that can be compared with analysis results of the flow analysis, and
the hardware processor verifies validity of the flow analysis by comparing the analysis results of the flow analysis with the orientation image, and
identifies an item that allows adjustment of the Talbot feature from among items constituting the mold design, based on a result of the verification.

4. The molding support apparatus according to claim 1, wherein
the production process is molding conditions for injection molding,
the hardware processor performs machine learning in which molding condition data indicating the molding conditions is an input, and the Talbot feature is an output, and
performs machine learning in which the Talbot feature is an input and performance data obtained by a test for the molded product is an output, and
identifies molding condition data optimized for a predetermined target value of the performance data.

5. The molding support apparatus according to claim 1, wherein
the production process is molding conditions for injection molding,
the hardware processor performs machine learning in which molding condition data indicating the molding conditions is an output, and the Talbot feature is an input,
performs machine learning in which the Talbot feature is an output and performance data obtained by a test for the molded product is an input, and
identifies performance data optimized for a predetermined target value of the molding condition data.

6. The molding support apparatus according to claim 1, wherein
the molded product contains a filler, and
the filler at least:
(1) has a grain size equivalent to a grating period of the X-ray Talbot imaging apparatus; (2) has an anisotropic shape; (3) has a fibrous form; or (4) has a fiber diameter equivalent to the grating period when in a fibrous form.

7. A molding support method in a molding support apparatus that supports production of a molded product of a composite material, the molding support apparatus performing:
calculating a Talbot feature of the molded product, based on a Talbot image acquired from an X-ray Talbot imaging apparatus that images the molded product; and
using the calculated Talbot feature, identifying an item that allows adjustment of the Talbot feature from among a plurality of types of items constituting a production process for producing the molded product.

8. A molding support apparatus that supports production of a molded product of a composite material, the apparatus comprising:
an image processor that generates an orientation image representing orientation of resin that is a material of the molded product,
the hardware processor calculates a feature of the molded product from the orientation image, and
identifies, using the calculated feature, an item that allows adjustment of the feature from among a plurality of types of items constituting a production process for producing the molded product.
